(19) United States
(12) Patent Application Publication
(10) Pub. No.: US 2013/0171394 A1
(43) Pub. Date: Jul. 4, 2013

(54) Polyamide Composition Containing Ionomer

(71) Applicants: Richard T. Chou, Hockessin, DE (US); Herbert Vernon Bendler, Wilmington, DE (US)

(72) Inventors: Richard T. Chou, Hockessin, DE (US); Herbert Vernon Bendler, Wilmington, DE (US)

(73) Assignee: E. I. DU PONT DE NEMOURS AND COMPANY, Wilmington, DE (US)

(21) Appl. No.: 13/341,736

(22) Filed: Dec. 30, 2011

(51) Int. Cl. B32B 1/08; B05D 3/12; B29C 47/00; C08L 77/00; C08K 5/435

(52) U.S. Cl. 428/36.9; 525/183; 525/179; 524/168; 264/331.18; 427/356

(57) ABSTRACT

Disclosed is a composition comprising polyamide comprising nylon-6 and optionally nylon-6,66, nylon-66, nylon-610, nylon-612, nylon-11, nylon-12 and an ionomer comprising an ethylene carboxylic acid copolymer, wherein 30 to 90% of the total carboxylic acid functionalities are neutralized to salts with a mixture of zinc cations and cations of a second metal selected from Group 1 of the Periodic Table of the Elements wherein the salts comprise from 20 to 90% equivalents of zinc. Articles prepared from the composition have improved salt stress crack resistance when exposed to zinc chloride solutions.

### FIELD OF THE INVENTION

The invention relates to a composition comprising polyamide and ionomer, and to articles prepared from the composition.

### DESCRIPTION OF PRIOR ART

Polyamides (nylons) are widely used in many industrial applications. Through modification, properties of polyamides can be tailored for the intended performance. For automotive vehicular applications, polyamides are used for tubing, hoses and cable jackets. Those applications require high flexibility, which is generally attained by adding plasticizer to the polyamides. Also, automotive applications for polyamides require resistance to metals salts, especially chloride salts.

Depending on the chemical nature of the polyamides, exposure to inorganic salt solutions has been known to cause stress cracking of polyamides (“salt stress cracking”, see “Stress Cracking of Nylon Polymers in Aqueous Salt Solutions Part 1 Stress-rupture behaviour,” M. G. Wyzgoski and G. E. Novak, Journal of Material Science, 1987, 1707-1714). Dunn and Sansom classified metal halides according to their ability to induce salt stress cracking (“The Stress Cracking of Polyamides by Metal Salts. Part 1. Metal Halides,” P. Dunn and G. F. Sansom, Journal of Applied Polymer Science, 1969, 13, 1641-1655). Zinc chloride was classified as a Type I salt, characterized as an extremely aggressive cracking agent for polyamides even at room temperature. Calcium chloride is milder in causing stress cracking and was classified as a Type II salt.

Polyamides with a higher ratio of methylene groups to amide (NHC═O), such as nylon-11 and nylon-12, have low susceptibility to salt stress cracking when exposed to chloride metal salt solutions such as ZnCl₂ solution. On the other hand, polyamides with a lower ratio of methylene groups to amide, such as nylon-6 and nylon-66, are highly susceptible to cracking, with nylon-6 more susceptible than nylon-66 (“Stress Cracking of Nylon Polymers in Aqueous Salt Solutions Part 2 Nylon Salt interactions,” M. G. Wyzgoski and G. E. Novak, Journal of Material Science, 1987, 1715-1723).

Accordingly, plasticized nylon-11 and nylon-12 with excellent salt stress crack resistance have been used for automotive applications. However, nylon-11 and -12 are unsuited for use at temperatures below about −40° C. or higher temperatures such as above 95° C. Products based on nylon-11 and nylon-12 also are expensive because of the high cost of those polymers. Poor salt resistance is one of the main barriers for lower cost nylon-6 and nylon-66 to be used in automotive applications where salt resistance is required. The presence of plasticizer in such polyamides makes them even more susceptible to salt stress cracking. Thus, highly flexible nylon-66 modified with plasticizer has limited industrial application due to its poor resistance to salt stress cracking.

It is desirable to form hoses having the zinc chloride resistance properties of nylon-11 or -12 while providing the cost and structural advantages of nylon-6.

Attempts to solve these problems have included blending nylon-66 with another polyamide having 6 to 11 methylene units per amide group such as nylon-610, nylon-612, nylon 11, nylon 12, excluding nylon-6, (Japanese Patent JP1986040263). Similar blends with more defined viscosity and viscosity ratios are described in Japanese Patent JP1993001304. Japanese Patent Application Publication JP1983176246 describes similar blends further comprising ionomers, for example zinc ionomers. Japanese Patent Application Publication JP2003277604 describes glass-reinforced blends. These blends exhibited improved CaCl₂ stress cracking resistance.

U.S. Patent Application Publication 2004/0058111 discloses compounded nylon-6, nylon-12 material for air brake systems with resistance to degradation by zinc chloride and moisture.

U.S. Patent Application Publication 2011/0052848 discloses polyamides made from 1,6-hexanediamine, and the dicarboxylic acids 1,10-decandioic acid, 1,12-dodecanedioic acid, or 1,14-tetradecanedioic acid and terephthalic acid in specified proportions that are particularly resistant to salt stressed (induced) corrosion cracking.

U.S. Pat. Nos. 4,745,143 and 4,801,633 disclose blends of polyamides, including nylon-6, with a water insoluble plasticizer and ionomers with improved CaCl₂ stress cracking resistance.

Ionomers are acid copolymers in which a portion of the carboxylic acid groups in the copolymer are neutralized to salts containing metal ions. U.S. Pat. No. 3,264,272 discloses a composition comprising a random copolymer of copolymerized units of an alpha-olefin having from two to ten carbon atoms, an alpha, beta-ethylenically-unsaturated carboxylic acid having from three to eight carbon atoms in which 10 to 90 percent of the acid groups are neutralized with metal ions, and an optional third mono-ethylenically unsaturated comonomer such as methyl methacrylate or ethyl acrylate.

It is known that thermoplastic blends based on ionomers and polyamides have a combination of desirable properties (see U.S. Pat. Nos. 4,174,358, 5,866,658, 6,399,684, 6,756,443 and 7,144,938). For example, U.S. Pat. No. 5,866,658 discloses a blend of an ionomer dispersed in a continuous or co-continuous polyamide phase in the range of 60/40 weight % to 40/60 weight % used for molded parts exhibiting toughness, high gloss, abrasion/scratch resistance, and high temperature properties. U.S. Pat. No. 6,399,684 discloses similar blends also containing phosphorous salts such as a hypophosphite salt.

The ionomers include zinc ionomers or ionomers with mixtures of zinc and magnesium cations, which have a neutralization of 65 to 100 mole percent of the acid groups. A higher degree of neutralization, however, may cause unacceptably high melt viscosity. To address the high melt viscosity of the blends of nylon and ionomer, one may use nylon of lower molecular weight and/or incorporate melt flow additives. For example, U.S. Pat. No. 6,756,443, “Ionomer/Polyamide Blends with Improved Flow and Impact Properties”, discloses an ionomer/polyamide blend with improved flow (e.g., lower melt viscosity) by incorporating a low molecular weight ethylene/acrylic acid copolymer (acid wax). The method adds complexity and also inevitably compromises properties. U.S. Pat. No. 7,144,938 discloses similar blends also containing one or more esters of montanic acid.

U.S. Patent Application Publication 2010/0029819 discloses heat resistant polyamides that may optionally include Zn, Li, Mg or Mn ionomers as tougheners.

U.S. Patent Application Publications 2005/0203253A1, 2005/020762A1, and 2006/0142489A1 disclose polyamides toughened with ionomers of ethylene copolymers containing a monocarboxylic acid and a dicarboxylic acid or derivative thereof. U.S. Patent Application Publication 2011/0020573 discloses a blend comprising a polyamide, an ionomer of an ethylene copolymer containing a monocarboxylic acid and a dicarboxylic acid or derivative thereof, and a sulfonamide. Examples therein have excellent ZnCl₂ stress crack resistance, but also have high melt viscosity.

U.S. Patent Application Ser. No. 61/440,559 discloses a blend comprising a polyamide, an ionomer of an ethylene copolymer containing a monocarboxylic acid and a dicarboxylic acid or derivative thereof, and a second ionomer.

U.S. Pat. No. 6,680,082 describes mixed ion ionomers, particularly ionomers with a mixture of zinc and magnesium, calcium, sodium or lithium for metal coating powder applications. U.S. Pat. No. 5,741,370 describes a mixture of sodium ionomer and zinc ionomer useful as a material for a solar module backskin. U.S. Patent Application Publication 2008/0097047 discloses blends of polyamides with ionomers, including blends with mixtures of zinc and sodium ionomers.

It is desirable to develop a highly flexible polyamide with high toughness, high abrasion and scratch resistance, and excellent salt stress crack resistance. It is also desirable that such compositions make use of more readily available polyamides such as nylon-6, which has much lower cost.

### SUMMARY OF THE INVENTION

The invention relates to a composition or a blend comprising, consisting essentially of, consisting of, or produced from

(a) about 50 to about 75 weight % of polyamide comprising nylon-6 (poly(ε-caprolactam)) and optionally up to 40 weight %, based on the total polyamide component, of nylon-6,66, nylon-66, nylon-610, nylon-612, nylon-11, nylon-12 or mixtures thereof;

(b) about 25 to about 50 weight % of an ionomer, wherein the ionomer comprises at least one copolymer comprising copolymerized comonomers of ethylene, 3 to 20 weight % of at least one α,β-unsaturated C₃-C₈ monocarboxylic acid, and 0 to 30 weight % of alkyl acrylate or alkyl methacrylate; and 30 to 90% of the total carboxylic acid functionalities are neutralized to salts with a mixture of zinc cations and cations of a second metal (M2) selected from Group 1 of the Periodic Table of the Elements (i.e. alkali metal cations such as sodium or lithium cations) wherein the salts comprise from 20 to 90% equivalents of zinc.

Preferably, the Zn/M2 equivalent ratio is from about 0.6 to about 6.

This composition addresses the poor salt stress crack resistance of polyamides with a lower ratio of methylene groups to amide moieties, such as nylon-6. Articles, such as in the form of extruded profiles, prepared from the composition have excellent salt stress crack resistance. As used herein, excellent salt stress crack resistance indicates that standard test plaques exposed to 50% aqueous zinc chloride solution at about 20 to about 25° C. for at least 24 hours and more preferably at least seven days exhibit no cracks when tested according to ASTM D1693.

Accordingly, the invention also provides a method for improving the salt stress crack behavior of a polyamide composition, comprising

(a) providing a polyamide composition comprising nylon-6 and optionally up to 40 weight %, based on the total polyamide component, of nylon-6,66, nylon-66, nylon-610, nylon-612, nylon-11, nylon-12 or mixtures thereof;

(b) melt blending the polyamide with an ionomer comprising at least one copolymer comprising copolymerized comonomers of ethylene, 3 to 20 weight % of at least one α,β-unsaturated C₃-C₈ monocarboxylic acid, and 0 to 30 weight % of alkyl acrylate or alkyl methacrylate; and 30 to 90% of the total carboxylic acid functionalities are neutralized to salts with a mixture of zinc cations and sodium or lithium cations, wherein the salts comprise from 20 to 90% equivalents of zinc; to provide a molten blend composition comprising about 50 to about 75 weight % of the polyamide and about 25 to about 50 weight % of the ionomer;

(c) shaping the molten blend composition into a defined shape;

(d) allowing the shaped molten blend composition to cool, thereby providing a shaped article;

wherein the salt stress crack behavior of the blend composition when tested according to ASTM D1693 is characterized by standard test plaques that exhibit fewer cracks than comparison test plaques consisting essentially of the polyamide composition of (a) when exposed to 50% aqueous zinc chloride solution at about 20 to about 25° C. for at least 24 hours.

The article may contain more than one layer including articles wherein the polymeric composition may be adhered to a woven or nonwoven textile. The extruded profile comprises tubing, hose, pipe, etc.

### DETAILED DESCRIPTION OF THE INVENTION

All references disclosed herein are incorporated by reference.

Unless stated otherwise, all percentages, parts and ratios are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range having a lower limit of 0, such component is an optional component (i.e., it may or may not be present). Such optional components, when present, are included in an amount preferably of at least about 0.1 weight % of the total weight of the composition or polymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of acrylic acid”. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. However, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

“Sheets” and “films” may be used interchangeably to describe articles wherein the compositions are processed into generally planar forms, either monolayer or multilayer. The processing method and/or the thickness may influence whether the term “sheet” or “film” is used herein, but either term can be used to describe such generally planar articles.

By a “vehicle” is meant any device which moves and transports people and/or freight or performs other functions. The vehicle may be self propelled or not, and may typically move on wheels, tracks, skids and/or runners. Applicable vehicles include automobiles, motorcycles, wheeled construction vehicles, farm or lawn tractors, trucks, trailers, all-terrain vehicles, snowmobiles and the like. Notable vehicles are automobiles, trucks, and motorcycles.

The compositions described herein provide vehicular parts with improved resistance to degradation due to exposure to salt. Such exposure may be typically encountered, for instance, by parts that come into contact with road salt or salt in and around oceans and other bodies of water. In normal operation in these environments vehicular parts, particularly those used in under-the-hood applications, are vulnerable to degradation over prolonged periods of time. Even intermittent exposure to salt over time can have adverse effects.

“In normal operation said part is exposed to salt” means that when tested in a normal vehicle configuration (as supplied by the manufacturer with all OEM guards in place, but no additional equipment present), the part is wet or otherwise exposed to a water solution on its exposed side in the following test. The vehicle is driven (or towed if not self propelling) at 50 km/h (about 30 mph) for 20 meters through a trough (so that all wheels go through the water or water solution) filled with water or a solution of a “marker” in water which is 1.5 cm deep. The part being tested is then checked to see if it is wet on the exposed side. If the part is wet it is considered exposed to salt in normal operation. If the part is normally hot in operation and the water would evaporate quickly, a marker substance is used in the water and part checked for the marker. The marker may be a salt (a white salt deposit will remain) of a chemical such as fluorescein whose presence can be found using ultraviolet light. If the marker chemical is on the part, the part is considered as exposed to salt in normal operation. This test simulates moving on a highway that may be covered with salt particles from melting ice or snow and/or a salt solution, and the resulting saltwater spray which is thrown onto the vehicle.

In developing blends of nylon-6 and ionomers, Zn ionomer has been preferred due to the interaction between Zn cations, divalent transition metal cations, and both amide and amine groups of polyamide. This physical interaction enhances the compatibility of the blend. lonomers with sodium or potassium cations were not preferred in blending with polyamides due to the poor compatibility. Also Na ionomers and K ionomers tend to absorb larger amount of water, and in general have poor UV stability (see for example U.S. Pat. No. 5,866,658). However, adding zinc-only ionomers to nylon-6 does not improve the ZnCl₂ salt stress crack resistance.

We have discovered a methodology for enhancing the salt crack resistance for polyamide materials, particularly for those with a lower ratio of methylene to amide groups in the polyamide. We have surprisingly discovered that polyamide modified with ionomers containing a mixture of zinc and sodium or lithium cations exhibits unexpectedly excellent salt resistance while retaining low water absorption. Preferred are ionomers with a mixture of Zn cations and Na cations.

Polyamides (abbreviated PA), also referred to as nylons, are condensation products of one or more dicarboxylic acids and one or more diamines, and/or one or more aminocarboxylic acids such as 11-aminododecanoic acid, and/or ring-opening polymerization products of one or more cyclic lactams such as caprolactam and laurolactam. Polyamides may be fully aliphatic or semi-aromatic.

Polyamides from single reactants such as lactams or amino acids, referred to as AB type polyamides are disclosed in Nylon Plastics (edited by Melvin L. Kohan, 1973, John Wiley and Sons, Inc.) and include nylon-6, nylon-11, nylon-12. Polyamides prepared from more than one lactam or amino acid include nylon-612.

Other well known polyamides include those prepared from condensation of diamines and diacids, referred to as AABB type polyamides (including nylon-66, nylon-610 and nylon-612), as well as from a combination of lactams, diamines and diacids such as nylon-6/66, nylon-6/610, nylon-6/66/610, nylon-66/610, or combinations of two or more thereof.

Fully aliphatic polyamides used in the resin composition are formed from aliphatic and alicyclic monomers such as diamines, dicarboxylic acids, lactams, aminocarboxylic acids, and their reactive equivalents. In this context, the term “fully aliphatic polyamide” also refers to copolymers derived from two or more such monomers and blends of two or more fully aliphatic polyamides. Linear, branched, and cyclic monomers may be used. Carboxylic acid monomers comprised in the fully aliphatic polyamides include, but are not limited to aliphatic dicarboxylic acids, such as for example adipic acid (C6), pimelic acid (C7), suberic acid (C8), azelaic acid (C9), decanedioic acid (C10) and dodecanedioic acid (C12). Diamines can be chosen among diamines with four or more carbon atoms, including but not limited to tetramethylene diamine, hexamethylene diamine, octamethylene diamine, decamethylene diamine, dodecamethylene diamine, 2-methylpentamethylene diamine, 2-ethyltetramethylene diamine, 2-methyloctamethylenediamine, trimethylhexamethylenediamine and/or mixtures thereof.

Preferred polyamides disclosed herein are homopolymers or copolymers wherein the term copolymer refers to polyamides that have two or more amide and/or diamide molecular repeat units. The homopolymers and copolymers are identified by their respective repeat units. For copolymers disclosed herein, the repeat units are listed in decreasing order of mole % repeat units present in the copolymer. The following list exemplifies the abbreviations used to identify monomers and repeat units in the homopolymer and copolymer polyamides (PA).
HMD hexamethylene diamine (or 6 when used in combination with a diacid)
AA Adipic acid
6 ε-Caprolactam
TMD 1,4-tetramethylene diamine
66 polymer repeat unit formed from HMD and AA
6 polymer repeat unit formed from ε-caprolactam

Note that in the art the term “6” when used alone designates a polymer repeat unit formed from ε-caprolactam. Alternatively “6” when used in combination with a diacid such as adipic acid, the “6” refers to HMD. In repeat units comprising a diamine and diacid, the diamine is designated first. Furthermore, when “6” is used in combination with a diamine, for instance 66, the first “6” refers to the diamine HMD, and the second “6” refers to adipic acid. Likewise, repeat units derived from other amino acids or lactams are designated as single numbers designating the number of carbon atoms.

The advantages of improved salt stress crack resistance are particularly useful for polyamides with a lower ratio of methylene units to amide groups, including those with a ratio of five or less methylene units per amide group, such as nylon-6, nylon-6/66 and most especially nylon-6.

The polyamide component may consist essentially of nylon-6. Nylon-6 is the most commonly used in the industry and has the lowest cost, but has the poorest ZnCl₂ resistance, so a method to improve its salt stress crack resistance is particularly desirable.

In other embodiments the polyamide composition comprises nylon-6 with up to 40 weight % of one or more additional polyamides selected from among the following: nylon-6,66, nylon-66, nylon-610, nylon-612, nylon-11 and nylon-12. In these embodiments the additional polyamide may be present in a range from a lower limit of about 0.1, 1.0, 5 or 10 weight % to an upper limit of 10, 20 or 40 weight % of the polyamide component. Replacement of a portion of the nylon-6 with any of these other polyamides that have inherently better metal halide resistance may enhance ZnCl₂ resistance compared to a composition with only nylon-6, but would increase cost.

The relative viscosity (RV) of the polyamide used herein is from about 2.5 to about 4.0, preferably from about 2.7 to about 3.5. Relative viscosity may be measured by different methods depending on the polyamide used. The RV of nylon-6 is commonly measured according to ISO Test Method 307 using a solution of 1% of polymer in 96% sulfuric acid. The RV of nylon-66 is commonly measured according to ISO Test Method 307 using a solution of 1% of polymer in 90% formic acid.

Most common nylon-6 grades used for molding and extrusion applications are suitable. For example, both Ultramid B33 (extrusion grade from BASF) with a RV of 3.3 and Ultramid B27 (molding grade from BASF) with a RV of 2.7 are suitable. Mixtures of nylon-6 with different RV may be used as the polyamide component. For example, mixtures of 30 to 70 weight % of nylon-6 with RV of around 2.7 with 70 to 30 weight % of nylon-6 with RV around 3.3 may be used. Salt stress crack resistance may be enhanced when higher RV polyamides are used. Accordingly, the higher RV polyamide is desirably used in at least 50 weight % of the polyamide mixture.

Because polyamides and processes for making them are well known to one skilled in the art, detailed description of their preparation is omitted herein for the interest of brevity.

Suitable ionomers are ethylene acid copolymers comprising in-chain copolymerized units of ethylene and in-chain copolymerized units of an α,β-unsaturated C₃-C₈ monocarboxylic acid; at least partially neutralized to salts comprising alkali metal cations such as sodium or lithium, or zinc cations, or a combination of such cations.

The α,β-unsaturated C₃-C₈ monocarboxylic acid may be acrylic acid or methacrylic acid, and the monocarboxylic acid may be present in the copolymer in an amount from about 3 to about 20 weight %, or about 12 to about 20 weight %, or about 4 to about 15 weight % of the copolymer.

The ethylene acid copolymer may also optionally include other comonomers such as alkyl acrylates and alkyl methacrylates wherein the alkyl groups have from 1 to 8 carbon atoms such as methyl acrylate, ethyl acrylate and n-butyl acrylate. These comonomers, when present, can be from 0.1 to about 30% based on the total weight of the copolymer, or about 3 to about 25%. The optional alkyl acrylates and alkyl methacrylates provide softer acid copolymers that after neutralization form softer ionomers.

Of note are ethylene acid dipolymers consisting essentially of copolymerized units of ethylene and copolymerized units of monocarboxylic acid (that is, the amount of alkyl acrylate or alkyl methacrylate is 0 weight %), and ionomers thereof. Preferably the monocarboxylic acid is acrylic acid or methacrylic acid.

The acid copolymers may be obtained by high-pressure free radical polymerization, wherein the comonomers are directly copolymerized with ethylene by adding all comonomers simultaneously. This process provides copolymers with “in-chain” copolymerized units derived from the monomers, where the units are incorporated into the polymer backbone or chain. These copolymers are distinct from a graft copolymer, in which the acid comonomers are added to an existing polymer chain via a post-polymerization grafting reaction, often by a free radical reaction.

These copolymers are treated so that at least some of the carboxylic acid groups present are neutralized to form salts with zinc or alkali metal cations to provide ionomers useful in the compositions described herein.

Neutralization of an ethylene acid copolymer can be effected by first making the ethylene acid copolymer and treating the copolymer with basic compound(s) comprising zinc and/or alkali metal cations. The copolymer may be neutralized so that from about 10 to about 90%, preferably 30 to 90% of the available carboxylic acid groups in the copolymer are neutralized to salts with at least one metal ion selected from lithium, sodium, zinc, or combinations of such cations. For example, from about 10 to about 70 or about 30 to about 70% of the available carboxylic acid groups may be ionized by treatment with basic compound(s) (neutralization) with at least one metal ion selected from sodium, zinc, or lithium.

Non-limiting, illustrative examples of ethylene acid copolymers useful in ionomers include E/15MAA, E/19MAA, E/15AA, E/19AA, E/15MAA, E/19MAA, E/10MAA/4iBA, E/10MAA/9.8iBA, E/9MAA/23nBA, (wherein E represents ethylene, MAA represents methacrylic acid, AA represents acrylic acid, iBA represents isobutyl acrylate, nBA represents n-butyl acrylate, and the numbers represents the weight % of comonomers present in the copolymer).

Suitable zinc- or alkali metal-neutralized ethylene acid copolymers or terpolymers are sold under the trademark SURLYN® brand resins by E.I. DuPont de Nemours and Company (DuPont) of Wilmington, Del. Mixed ion ionomers are not commercially available. As described in greater detail below, a mixed ion ionomer can be prepared by melt blending a zinc-neutralized ionomer with an alkali metal-neutralized ionomer.

The mixed ion ionomer useful for blending with polyamides as described herein may be obtained by neutralizing an acid copolymer described above with a combination of a basic compound containing zinc cations and a basic compound containing alkali metal cations. Another method may be using an alkali metal ionomer or combination of alkali metal ionomers and neutralizing to a higher level with a basic compound containing zinc cations.

Alternatively, the mixed ion ionomer may be obtained by combining an ionomer containing zinc cations and an ionomer containing alkali metal cations. In such cases, the ethylene acid copolymer used as the base polymer in the zinc ionomer may be the same as, or different from, the ethylene acid copolymer used as the base polymer in the alkali metal ionomer. Also, the different ionomers may be melt-blended together with the polyamide, thereby forming the mixed ion ionomer and blending with the polyamide in a single step.

The composition or blend can comprise 0.0001, 0.01 or 0.1 or 1 weight % to about 1, 5, 10, 20, or 30 weight %, based on the weight of the entire composition including the polyamide/mixed ion ionomer blend, of optional additives including stabilizers, antioxidants, ultraviolet ray absorbers, hydrolytic stabilizers, anti-static agents, dyes or pigments, fire-retardants, processing aids such as lubricants, antiblock agents, release agents, or combinations of two or more thereof. Lubricants of note include salts of fatty acids such as zinc stearate, which may be added at about 0.1 to 1 weight % of the total composition.

The blend may also contain phosphorous salts such as a hypophosphite salt. Suitable phosphorous salts for use in the blends are described in greater detail in U.S. Pat. No. 6,399,684. The salts, including sodium, lithium, or potassium hypophosphite may be added to the blend composition in about 0.1 to about 3 weight % of the composition. Hypophosphite salts may provide improved morphological or physical properties to the blend such as increased Vicat temperature and/or improved tensile properties.

Of note is a composition as described herein consisting essentially of (1) a polyamide as described above; (2) a mixed-ion ionomer as described above; and (3) hypophosphite salt.

The composition may also contain plasticizers. A sulfonamide can be used as plasticizer when added to a blend of polyamide and mixed ion ionomer so that it retains its flexibility under use conditions particularly when subject to elevated temperatures. The sulfonamide can be used in an amount of about 2 to about 20% and preferably from about 5 to about 15%, based on the total weight of the composition. The sulfonamide may be an alkyl aryl sulfonamide, where the alkyl group has 1 to 4 carbon atoms such as n-methyl benzene sulfonamide, n-ethyl benzene sulfonamide, n-propyl benzene sulfonamide, n-isopropyl benzene sulfonamide, n-isobutyl benzene sulfonamide, n-butyl benzene sulfonamide, or combinations of two or more thereof. The n-butyl benzene sulfonamide is readily available and provides optimum flexibility to articles made from the composition.

Of note is a composition as described herein consisting essentially of a (1) polyamide as described above; (2) a mixed-ion ionomer as described above; and (3) a sulfonamide, wherein the composition is substantially free of any additional thermoplastic materials.

Also of note is a composition as described herein consisting essentially of a (1) polyamide as described above; (2) a mixed-ion ionomer as described above; (3) hypophosphite salt; and (4) a sulfonamide.

The composition or blend can optionally comprise additional non-ionomer thermoplastic materials blended with the polyamide and ionomer to allow one to more easily modify the properties of the composition by manipulating the amount and type of additional components present in the composition in addition to varying the percentages of the monomers in the ethylene acid copolymer; or to allow for easier, lower cost manufacture of the composition by allowing one to prepare fewer base resins that can be subsequently modified to obtain desired properties, or to substitute a portion of the composition with a less expensive material. To retain the desired benefits, the additional thermoplastic material may be present in the composition in an amount up to about 30% of the total polymeric material, such as from a lower limit of 1 or 5 weight % to an upper limit of 10, 15 or 20 weight % of the total polymeric material.

Non-ionomers include copolyetheramides, elastomer polyolefins, styrene diene block copolymers (e.g., styrene-butadiene-styrene (SBS)), thermoplastic elastomers, thermoplastic polyurethanes (e.g., polyurethane), polyetherester, polyether-urea, PEBAX (a family of block copolymers based on polyether-block-amide, commercially supplied by Atochem), styrene(ethylene-butylene)-styrene block copolymers, etc., polyesters, polyolefins (e.g., polyethylene, polypropylene, or ethylene/propylene copolymers), ethylene copolymers (with one or more comonomers including vinyl acetate, (meth)acrylates, (meth)acrylic acid, epoxy-functionalized monomer, CO, etc., functionalized polymers with maleic anhydride, or epoxidization), grafting, elastomers such as EPDM, metallocene catalyzed PE and copolymer, ground up powders of the thermoset elastomers, or combinations of two or more thereof.

Some of the thermoplastic materials may be useful as impact modifiers for the polyamide-mixed ionomer blend. Example impact modifiers include polyethylene, ethylene-propylene dipolymers or terpolymers with an additional α-olefin grafted with a carboxylic acid or anhydride, or ethylenepropylene diene mononomer (EPDM) grafted with a carboxylic acid or anhydride. Preferably the anhydride is maleic anhydride. Such impact modifiers are described in greater detail in U.S. Pat. No. 6,420,481. The impact modifiers may be included in the composition in about 1 to about 15 weight %, or from about 5 to about 10 weight %. Inclusion of impact modifiers may be useful in providing good low-temperature impact resistance.

The tensile modulus of the blend, as measured by ASTM D1708 at 23° C., is preferably less than 1200 MPa (megapascals) or more preferably less than 1000 MPa, most preferably less than 800 MPa.

The blend may be produced by any means known to one skilled in the art, e.g., dry blending/mixing followed by melt blending such as by extrusion to produce the composition. The components of the blend may be melt blended in a single blending operation. Alternatively, the mixed ion ionomer may be prepared in a first step and then subsequently melt blended with the polyamide.

The composition may be formed into articles by various means known to those skilled in the art. For example, the composition may be extruded, laminated, molded (e.g. injection molded, blow molded or overmolded), cut, milled or the like to provide an article that is in a desired shape and size.

Articles comprising the thermoplastic composition also may be further processed. For example, portions of the composition (such as, but not limited to, pellets, slugs, rods, ropes, sheets and molded or extruded articles) may be subjected to thermoforming operations in which the composition is subjected to heat, pressure and/or other mechanical forces to produce shaped articles. Compression molding is an example of further processing. The composition can be used to fabricate vehicular parts, particularly those parts that are exposed to salt in normal vehicle operation. Such vehicular parts include cooling system components, intake manifolds, oil pans, transmission cases, electrical and electronic housings, fuel system components, filter housings, coolant pump covers, and radiator end tanks. A particularly useful part is fluid (liquid and/or gas) tubing or hose, used to transfer fluid from one portion of the vehicle to another. These ionmer-polyamide compositions have properties that make them especially useful for tubes and hoses, for example one or more of good resistance to heat, the various fluids found in vehicles especially fuel, hydraulic fluid, and cooling fluid, flexibility (especially when containing plasticizers) and good high pressure burst resistance. Air brake hoses are notable.

The compositions may be shaped by profile extrusion. A profile is defined by having a particular shape and by its process of manufacture is known as profile extrusion. An extruded profile is not film or sheeting, and thus the process for making profiles does not include the use of calendering or chill rolls, nor is it prepared by injection molding processes. A profile is fabricated by melt extrusion processes that begin by (co)extruding a thermoplastic melt through an orifice of a die (such as an annular die with a mandrel) forming an extrudate capable of maintaining a desired shape. The extrudate is typically drawn into its final dimensions while maintaining the desired shape and then quenched in air or a water bath to set the shape, thereby producing a profile. In the formation of simple profiles, the extrudate preferably maintains shape without any structural assistance. Common profile extruded articles include tubing or hoses. Monolayer or multilayer tubing may be prepared.

Tubing assemblies for the transport of liquids and vapors are well known in the art. Clarity of the tubing may be desirable for visual observation of the fluids being transferred, but is not essential in many instances. Furthermore, depending on the use of the tubing, there may be exposure to extremely low temperatures and/or extremely high temperatures. The compositions as described herein provide a good combination of metal halide resistance, toughness, flexibility, and in some cases clarity, making them suitable for preparation of profiles such as tubing.

The composition may be profile extruded to provide articles such as hoses for air conditioning; refrigeration; dispensing and transfer equipment for fluids including foods and beverages, compressed air or gases, paint, chemicals such as solvents, alkalis, dilute mineral or organic acids, and the like, petroleum products, fuel and oil; coolant lines, grease lines, hydraulic lines, auto hoses or tubing, laboratory uses, instrumentation, air brake hoses, etc.

Some examples of hoses and tubing using nylon for which the polyamide-mixed ion ionomer blends may be substituted include those described in U.S. Pat. Nos. 5,849,382 and 6,475,582, U.S. Patent Application Publications 2003/0145896 and 2004/0096615, and Annual Technical Conference —Society of Plastics Engineers (1997), 55th (vol. 3), 2789-2793.

The polyamide mixed ion ionomer composition described herein may be used as the polymeric composition for hoses in which surface temperatures in operation may be up to about 90° C. The composition provides desired flexural modulus, improved salt crack resistance and improved aging compared to previous compositions. The composition may also provide superior scratch and abrasion resistance.

With some tubular shapes, support means such as fiber or metal reinforcement may be used to assist in shape retention. Reinforcement may be in the form of braided reinforcing layers around the outside surface of a base tube of the composition or incorporated between layers of polymeric material. The reinforcing layers may include braided polyester, polyamide or aramid fibers. Adhesives may be used to adhere the reinforcing layer to the composition. For example, U.S. Pat. No. 4,130,139 discloses crosslinked polyurethane used as an adhesive for bonding polyamide-11 to such reinforcing layers. In some cases, the thermoplastic material may be melt processed so that it fills the voids between strands or braids of reinforcing material, resulting in the reinforcing material embedded within a layer of the composition.

The polyamide mixed ion ionomer composition may be coated onto a tubular substrate, such as metal tubing prepared from aluminum, steel, copper and/or zinc. The metal tubing may be treated to improve adhesion of the composition to the surface of the metal and/or improve corrosion resistance. Notable tubes or pipes that may be coated include olive chromated zinc-coated steel tubing, such as described in U.S. Pat. No. 5,849,382.

In a representative process, when extruding the polyamide mixed ion ionomer layer onto the tube, the tube is heated approximately to the temperature of the composition to be extruded, which may be in the range of about 240 to 260° C. This heating step permits a particularly good adhesion of the composition to the tubing substrate. The pipe temperature does not need to be identical to the temperature of the polyamide blend to be extruded. However, it is desirable to achieve at least an approximation of temperatures to avoid subsequent peeling of the plastic jacket layer from the tube, which can occur during extrusion onto a cold pipe.

Normally, the difference in temperature between the pipe and the molten composition may be from a few degrees to about 20° C. or about 30 C.°, or higher.

The surface of the pipe may be roughened to provide enhanced bonding with the extruded composition so that it is particularly resistant to peeling. After the treated pipe has been chilled in a water bath or any other liquid bath, the pipe will have a sufficient mechanical resistance for further processing, for example, for conveyance on rollers.

Flexible pipes or liners for oil or gas pipelines may also comprise the composition. In the operation of offshore oil or gas deposits it is necessary to use flexible pipes to connect the various devices around the platform. The pipes must withstand hot oil, gas, water and mixtures of at least two of these products for periods possibly as long as 20 years. Excellent salt stress crack resistance is also important for these applications. These pipes may consist of a non-impermeable metal inner layer formed by a profiled metal tape wound in a helix, such as an interlocked strip, which gives the pipe shape, a polymeric composition extruded over this layer in order to provide sealing and, finally, other protective and reinforcing layers, such as metal fiber plies and rubber plies.

U.S. Pat. No. 6,913,043, U.S. Patent Application Publications 2004/0058111, PCT Patent Application Publications WO2004/052993, WO2007/041722, and WO2007/041723 describe various pipe and tubing uses and constructions using prior polyamide compositions. The composition disclosed herein may be used as an alternative polyamide composition for use in those applications and constructions.

### EXAMPLES

The following Examples are merely illustrative, and are not to be construed as limiting the scope of the invention.

### Materials

For the materials listed below, Relative viscosity (RV) measured according to ISO 307 was reported by the commercial supplier. Melt Index was determined according to ASTM D1238 at 190° C. using a 2.16 kg weight.

N-6-A: nylon-6, RV of 2.62 to 2.83, available under the tradename ULTRAMID® B27-E01 from BASF.

N-6-B: nylon-6, RV of 3.19 to 3.41, available under the tradename ULTRAMID® B33 from BASF.

ION-1: a Zinc ionomer based on an ethylene methacrylic acid dipolymer with 15 weight % of MAA, neutralized to salts with Zn cations (58 % neutralization), with 800 ppm moisture, MI of 0.7 g/10 minutes.

ION-2: a Na ionomer based on an ethylene methacrylic acid dipolymer with 15 weight % of MAA, neutralized to salts with Na cations (59 % neutralization), with 800 ppm moisture, MI of 0.9 g/10 minutes.

ION-3: a Zn ionomer based on an ethylene methacrylic acid dipolymer with 19 weight % of MAA, neutralized to salts with Zn cations (36 % neutralization), MI of 1.3 g/10 minutes.

ION-4: a Na ionomer based on an ethylene methacrylic acid dipolymer with 19 weight % of MAA, neutralized to salts with Na cations (45% neutralization), MI of 4.5 g/10 minutes.

ION-5: a Li ionomer based on an ethylene methacrylic acid dipolymer with 15 weight % of MAA, neutralized to salts with Li cations (46% neutralization), MI of 1.8 g/10 minutes.

IM-1: a maleic anhydride grafted polyethylene with density of 0.87 g/cm³, Melt Flow Rate (190° C./2.16 kg) of 1.6 g/10 min and melting point of 50° C., available from DuPont under the tradename Fusabond® N493.

ZnO concentrate: 30 weight % of ZnO (based on total weight of concentrate) in an ethylene/methacrylic acid dipolymer (5 weight % of MAA based on weight of dipolymer).

BBS: N-Butylbenzene sulfonamide employed as a plasticizer, available under the tradename UNIPLEX® 214 from Unitex Chemical Corp.

Zinc stearate: commercial grade.

Sodium hypophosphite: commercial grade.

Extrusion/Processinq Conditions

All blend samples were made on a 30-mm twin-screw extruder, typically with 260° C. barrel temperature settings and screw speed of 300 rpm. Polyamide and ionomer were fed at the back end of the extruder, followed by an intense kneading section in the extruder screw to disperse these ingredients. When included, plasticizer was injected into the extruder barrel after the initial mixing section, and this liquid injection was followed by additional intense mixing elements. The melt strand from the extruder was water quenched and cut into pellets for collection and subsequent molding and evaluation.

Injection Molding

Testing specimens, plaques and tensile bars were molded on either a 1.5 oz Arburg or a 6 oz Nissei injection molding machine, using a standard screw and nozzle. Barrel settings were typically 260° C., and injection pressure and cycle time were adjusted to accommodate the melt viscosity of the given sample.

Methods Employed for Testing

The tensile strength, modulus and elongation at break were measured according to ASTM D1708, “Standard Test Method for Tensile Properties of Plastics by use of Microtensile Specimens” using crosshead speed of 10 in/min. Dimensions of specimens were 0.185 inch width×0.125 inch thickness×0.875 inch length.

Melt viscosity was measured at 250° C. using a Kayeness melt rheometer of a 0.04 inch×0.8 inch 20/1 LID orifice. A six minute holdup/melt time in the rheometer barrel was used before measurements were taken. Melt viscosity was measured at shear rates of 2998, 1189, 470, 186, 75, 29 and 12 sec⁻¹. Only data at 12 sec⁻¹ are reported herein for comparison.

Notched Izod impact was measured on (5 inch×0.5 inch×0.125 inch) test bars according to ASTM D256.

The water absorption was measured by immersing a specimen of 3 inch×3 inch×0.125 inch plaques in water at room temperature (20 to 25° C.) for 7 days or at 80° C. for four hours, removing the specimen from water, blotting the water from the surface of the plaque and weighing to determine weight gain.

The environmental stress cracking test was measured according to ASTM D1693. The purpose of this test is to measure the chemical resistance of a compound by artificially stimulating a stress introduced into a sample by means of a stress crack or “nick.” Ten specimens of each composition sample were used. The size of the test specimen was 1.5 inch long×0.5 inch wide×0.125 inch thick. The test specimens were nicked, then placed into a holder so that they were held in a bent configuration with the nicked side facing up. The specimens were then immersed in 50 weight % aqueous zinc chloride solution at room temperature (RT), about 20 to about 25° C. The specimens were inspected periodically for formation of cracks which indicated failure of the specimen. At the end of 168 hours (7 days), the test was ended and the total number of failures out of the ten specimens tested was recorded. When no samples failed during that time, the test results were reported as being greater than 7 days. Similar tests were also conducted using a zinc chloride solution temperature-controlled to about 50° C.

Listed in Tables 1 through 7 are representative data for blends as described herein.

Compositions using nylon-6 were prepared and processed into test specimens as described above using the amounts of components summarized in Table 1. In Table 1, the six samples are blends of similar composition except that Comparative Examples 1, 2 and 3 are blends of nylon-6 and a Zn ionomer, while Examples 1, 2 and 3 are blends of nylon-6 and a mixture of Na ionomer and Zn ionomer. The ionomers employed were a Na ionomer and a Zn ionomer, both based on E/MAA (85/15 weight %) with about same melt flow index. For most of the samples in Table 1, the samples were prepared in a one-step process, blending polyamides, and the ionomer(s) and together in one extrusion melt blending. Example 3 was prepared in a two-step process. The mixed ion ionomer was first prepared by melt blending of ION-1 and ION-2 in a 50/50 weight % blend, and then melt blending with nylon-6 in a second extrusion. In the following Tables, Equivalent Ratio is the number of equivalents provided by the zinc salts divided by the number of equivalents provided by the sodium salts.

TABLE 1

| | | | | | | | Equivalent |
|---|---|---|---|---|---|---|---|
| | Polyamide | | Ionomer | | Zn Stearate | Neutralization | Ratio of |
| Example | Type | Weight % | Type | Weight % | Weight % | Level | Zn/M2 |
| C1 | N-6-B | 64.5 | ION-1 | 34.75 | 0.75 | 58 | 100% Zn |
| C2 | N-6-A | 59.55 | ION-1 | 39.7 | 0.74 | 58 | 100% Zn |
| C3 | N-6-A | 19.85 | ION-1 | 39.7 | 0.74 | 58 | 100% Zn |
| | N-6-B | 39.7 | | | | | |
| 1 | N-6-B | 64.25 | ION-1 | 17.5 | 0.75 | 58.5 | 0.98 |
| | | | ION-2 | 17.5 | | | |
| 2 | N-6-B | 64.25 | ION-1 | 10 | 0.75 | 58.3 | 0.39 |
| | | | ION-2 | 25 | | | |
| 3 | N-6-B | 64.25 | ION-1 | 17.5 | 0.75 | 58.5 | 0.98 |
| | | | ION-2 | 17.5 | | | |
| C4 | N-6-B | 64.5 | ION-2 | 34.75 | 0.75 | 59 | 100% Na |
| 5 | N-6-B | 64.25 | ION-1 | 17.5 | 0.75 | 52 | 1.26 |
| | | | ION-5 | 17.5 | | | |
| C6 | N-6-B | 64.5 | ION-5 | 34.75 | 0.75 | 46 | 100% Li |
| 7 | N-6-A | 19.25 | ION-1 | 17.5 | 0.75 | 58.5 | 0.98 |
| | N-6-B | 45 | ION-2 | 17.5 | | | |
| 8 | N-6-A | 32.1 | ION-1 | 17.5 | 0.75 | 58.5 | 0.98 |
| | N-6-B | 32.1 | ION-2 | 17.5 | | | |
| 9 | N-6-A | 45 | ION-1 | 17.5 | 0.75 | 58.5 | 0.98 |
| | N-6-B | 19.25 | ION-2 | 17.5 | | | |
| 10 | N-6-A | 29.8 | ION-1 | 19.9 | 0.75 | 58.5 | 0.98 |
| | N-6-B | 29.8 | ION-2 | 19.9 | | | |

The properties of the compositions are summarized in Table 2.

TABLE 2

| | | | | Tensile Properties | | | Melt Viscosity |
|---|---|---|---|---|---|---|---|
| | ZnCl₂ Stress Test | | | (125° C.) | | | (250° C. at |
| | (time to fail) | | | Modulus | Strength | Elongation | 12 sec⁻¹ shear rate) |
| Example | RT | | 50° C. | (MPa) | (MPa) | (%) | (Pa sec) |
| C1 | <24 | h | NA | 98.8 | 32.3 | 365 | 3634 |
| C2 | <24 | h | NA | 115 | 40.5 | 400 | 1297 |
| C3 | <24 | h | NA | 80.7 | 26.2 | 390 | 1985 |
| 1 | >7 | days | >7 days | 93.3 | 27.3 | 350 | 2240 |
| 2 | >7 | days | >7 days | 94 | 28.9 | 360 | 1990 |
| 3 | >7 | days | >7 days | 100.3 | 30.5 | 340 | 2406 |
| C4 | >7 | days | NA | 84.0 | 23.8 | 330 | 1915 |
| 5 | >7 | days | NA | 88.9 | 18.9 | 260 | 1627 |
| C6 | >7 | days | NA | 82.9 | 19.9 | 310 | 1341 |
| 7 | >7 | days | NA | 91.3 | 30.3 | 350 | NA |
| 8 | <24 | h | NA | 121 | 37.2 | 370 | NA |
| 9 | <24 | h | NA | 124.1 | 39.4 | 460 | NA |
| 10 | >7 | days | NA | 82 | 27 | 360 | NA |

Nylon-6 mixed with a zinc-containing ionomer (Comparative Examples C1, C2 and C3) had poor salt stress crack resistance, failing the ZnCl₂ salt test within one day at ambient temperature. Examples 1, 2 and 3, with a mixture of ionomers with sodium and zinc ions, had excellent salt stress crack resistance even at elevated temperatures. The tensile properties were relatively unaffected when using the mixed ion combination of ionomers compared to the single ion ionomer. Blending the zinc and sodium ionomers before blending with the polyamide (Example 3) resulted in slightly higher tensile modulus and tensile strength than in the one-step blending process (Example 1). Melt viscosity was reduced when the mixed ion ionomers were used.

Comparative Example 4, a blend with an all-sodium ionomer component, had good stress crack performance, but had significantly reduced tensile modulus and tensile strength compared to Comparative Example Cl and Examples 1, 2 and 3. This blend is also likely to have high water absorption.

Example 5, a blend comprising a zinc-lithium mixed ionomer component, had superior performance to Comparative Example C1 in the stress crack test. It had a larger drop in tensile modulus and tensile strength compared to Examples 1, 2, and 3. This may be due in part to the lower neutralization level of the ionomer. Comparative Example 6, a blend with an all-lithium ionomer component, had good stress crack performance, but had significantly reduced tensile modulus and tensile strength compared to Comparative Example C1 and Example 5.

Examples 7 through 10 show the effect of using blends with varied amounts of nylon-6 materials with different relative viscosities in combination with a mixed ion ionomer component. Example 7 had performance comparable to Example 1, despite the inclusion of about 19 weight % of N-6-A. Increasing the amount of N-6-A (Examples 8 and 9) significantly increased the tensile properties but decreased the stress crack performance. Using more mixed ion ionomer (Example 10 compared to Example 8) provided improved stress crack performance.

The samples listed in Table 3 are blends of similar compositions except that the ionomer component varied. Comparative Example 11 is a blend of nylon-6 and a Zn ionomer, while Example 12, 13, 14 and 15 are blends of nylon-6 and a mixture of Na ionomer and Zn ionomer. The ionomers employed were a Na ionomer and a Zn ionomer, both based on an E/MAA (81/19 weight %) copolymer. Neutralization with zinc concentrate during melt blending made Example 15 a Na/Zn ionomer. The 3 weight % of ZnO concentrate gave rise to about 22.3 mole % of additional neutralization of the acid groups of the ionomer in Example 15.

TABLE 3

| | | | | | |
|---|---|---|---|---|---|
| Example | C11 | 12 | 13 | 14 | 15 |

Composition (by weight %)

| | | | | | |
|---|---|---|---|---|---|
| N-6-B | 59.1 | 59.1 | 59.1 | 59.1 | 59.1 |
| ION-3 | 37 | 28.5 | 18.5 | 8.5 | 0 |
| ION-4 | 0 | 8.5 | 18.5 | 28.5 | 37 |
| ZnO Concentrate | 3 | 3 | 3 | 3 | 3 |
| Zinc Stearate | 0.75 | 0.75 | 0.75 | 0.75 | 0.75 |
| Sodium Hypophosphite | 0.15 | 0.15 | 0.15 | 0.15 | 0.15 |
| Neutralization (%) | 63 | 65 | 67 | 70 | 72 |
| Equiv. Ratio of Zn/Na | 100% Zn | 5.3 | 2.0 | 1.0 | 0.6 |

ZnCl₂ Stress Test (time to fail)

| | | | | | | |
|---|---|---|---|---|---|---|
| | | | 50% passed at | | | |
| Measured at RT | <24 | hrs | 7 days | >7 days | >7 days | >7 days |
| Measured at 50° C. | <15 | min | >7 days | NA | >7 days | >7 days |

Tensile Properties at 23° C.

| | | | | | |
|---|---|---|---|---|---|
| Tensile modulus (MPa) | 803 | 834 | 827 | 781.1 | 714.7 |
| Tensile strength (MPa) | 63.3 | 63.2 | 88.2 | 76.7 | 87.6 |
| Elongation at break (%) | 230 | 250 | 335 | 350 | 350 |

Tensile Properties at 125° C.

| | | | | | |
|---|---|---|---|---|---|
| Tensile modulus (MPa) | 88.4 | 87.5 | 80 | 83.2 | 93.5 |
| Tensile strength (MPa) | 28.2 | 25 | 29 | 25.5 | 27.1 |
| Elongation at break (%) | 290 | 230 | 315 | 300 | 320 |

Capillary Rheology at 250° C. (shear viscosity, Pa · sec)

| | | | | | |
|---|---|---|---|---|---|
| 12 sec⁻¹ shear rate | 6309 | 5053 | 3530 | 3369 | 2892 |

Water absorption (weight %)

| | | | | |
|---|---|---|---|---|
| 1.6 | 1.5 | 1.7 | 2.4 | 3.7 |

Izod Impact accordinq to ASTM D256 at −20° C.

| | | | | | |
|---|---|---|---|---|---|
| KJoule/Meter² (KJ/M²) | 108 | 67.4 | 91.2 | 30.6 | 27.3 |

Compared to Comparative Example C11, Examples 12, 13, 14 and 15, compositions prepared from ionomers with a mixture of sodium and zinc ions, had excellent salt stress crack resistance at both room temperature (20-25° C.), and at 50° C. The tensile properties at both 23° C. and 125° C. were relatively unaffected when using the mixed ion combination of ionomers compared to the single ion ionomer. The samples all exhibited excellent mechanical properties. There is a clear demonstration that a blend of nylon-6 with ionomers with a mixture of sodium and zinc ions, such as Example 13, attained excellent ZnCl₂ resistance, mechanical properties and high impact resistance. Also unexpectedly, a blend of nylon-6 with ionomers with a mixture of sodium and zinc ions exhibited lower melt viscosities. Lower melt viscosities may be beneficial in manufacturing of finished products from these compositions.

Examples 12 and 13 showed low water absorption, comparable to the all-zinc Comparative Example C11. However, as the mole % of Na cations in the ionomer component increased, there was an increase in water absorption and a decrease in impact resistance. Thus, it may be desirable to limit the amount of sodium ions in the mixed ionomer to the lowest amount necessary to achieve the desired salt stress cracking resistance. Preferably, the equivalent ratio of Zn to Na (or Li) is 0.7 to 6.0, more preferably 1 to 6, or 1 to 5.

Blends containing plasticizer are summarized in Table 4. Comparative Example C12 had no ionomer and Comparative Example C13 used an ionomer 100% neutralized with zinc. In Example 16, the neutralization level was 58.5 and the equivalent ratio of Zn to Na was 0.98. In Examples 17-20, the neutralization level was 58.7 and the equivalent ratio of Zn to Na was 0.39.

TABLE 4

| | Polyamide | | | BBS | Zn |
|---|---|---|---|---|---|
| | (N-6-B) | Ionomer | | plasticizer | Stearate |
| Example | Weight % | Type | Weight % | Weight % | Weight % |
| C12 | 92 | — | 0 | 8 | |
| C13 | 55.7 | ION-1 | 37.6 | 6 | 0.71 |
| 16 | 55.7 | ION-1 | 18.8 | 6 | 0.71 |
| | | ION-2 | 18.8 | | |
| 17 | 62.97 | ION-1 | 9.8 | 2 | 0.74 |
| | | ION-2 | 24.5 | | |
| 18 | 61.68 | ION-1 | 9.6 | 4 | 0.72 |
| | | ION-2 | 24 | | |
| 19 | 60.4 | ION-1 | 9.4 | 6 | 0.71 |
| | | ION-2 | 23.5 | | |
| 20 | 59.1 | ION-1 | 9.2 | 8 | 0.69 |
| | | ION-2 | 23 | | |

Table 5 summarizes the zinc salt resistance and tensile properties of the blends.

TABLE 5

| | ZnCl₂ Stress Test | | | Tensile Properties (125° C.) | | |
|---|---|---|---|---|---|---|
| | (time to fail) | | | Modulus | Strength | Elongation |
| Example | RT | | 50° C. | (MPa) | (Mpa) | (%) |
| C12 | < 30 | minutes | NA | 182.9 | 67.7 | 493 |
| C13 | <4 | hrs | NA | 69.5 | 26.7 | 370 |
| 16 | >7 | days | >7 days | 54 | 20.7 | 350 |
| 17 | >7 | days | >7 days | 83.6 | 24.3 | 340 |
| 18 | >7 | days | >7 days | 88.5 | 29.4 | 360 |
| 19 | <4 | hrs | NA | 85.1 | 31.5 | 380 |
| 20 | <4 | hrs | NA | 93.8 | 31.3 | 380 |

Even with eight weight % of plasticizer, Comparative Example C12 was still very rigid. Moreover, it is known that the presence of plasticizer in polyamides, especially nylon-6, has an adverse effect on salt stress crack resistance, as shown by the very short time to failure. Addition of mixed salt ionomers not only enhanced ZnCl₂ stress resistance but also provided improved flexibility. The ZnCl₂ resistance data shown in Table 5 demonstrate that a blend of nylon-6 and an ionomer of mixed Na/Zn ions containing n-butylbenzene sulfonamide (BBS) plasticizer can pass the ZnCl₂ test. However, as the plasticizer content increased, the ZnCl₂ resistance was compromised. Example 18 showed the best combination of ZnCl₂ stress resistance and tensile properties.

As summarized in Table 6, the three samples all contain 60 weight % of nylon-6 (Ultramid B33,), a sodium ionomer and a zinc ionomer at 1:1 ratio, and a soft maleic anhydride-grafted polyethylene as an impact modifier. Such impact modifiers are often used to enhance impact resistance and render flexibility.

TABLE 6

| | Polyamide | | | | |
|---|---|---|---|---|---|
| | (N-6-B) | Ionomer | | IM-1 | Zn Stearate |
| | Weight | | Weight | Weight | Weight |
| Example | (parts) | Type | (parts) | (parts) | (parts) |
| 21 | 60 | ION-1 | 17.5 | 5 | 0.5 |
| | | ION-2 | 17.5 | | |
| C14 | 60 | ION-1 | 12.5 | 15 | 0.5 |
| | | ION-2 | 12.5 | | |
| C15 | 60 | ION-1 | 10 | 20 | 0.5 |
| | | ION-2 | 10 | | |

The results of ZnCl₂ stress testing and tensile properties are summarized in Table 7.

TABLE 7

| | ZnCl₂ | Tensile Properties | | | | | |
|---|---|---|---|---|---|---|---|
| | Stress Test | 23° C. | | | 125° C. | | |
| | 23° C. | Modulus | Strength | Elongation | Modulus | Strength | Elongation |
| Example | (time to fail) | (MPa) | (Mpa) | (%) | (MPa) | (Mpa) | (%) |
| 21 | >7 days | 782 | 70.0 | 360 | 81.4 | 18.4 | 280 |
| C14 | <4 hours | 657 | 69.2 | 360 | 90.6 | 21.8 | 325 |
| C15 | <4 hours | 612 | 65.0 | 350 | 95.6 | 23.0 | 280 |

Based on the tensile modulus measured at 23° C., as the amount of IM-1 increased, the sample became more flexible, i.e., lower tensile modulus. In theory, a sample of more flexibility encounters less stress in the ZnCl₂ resistance test. Yet, the ZnCl₂ resistance data suggests that as IM-1 replaced the mixed ion ionomer, the ZnCl₂ resistance became poor. This suggests that IM-1, while providing flexibility, does not provide ZnCl₂ resistance.

The samples can be extruded into tubes with an outer diameter of 8.35 mm and an inner diameter of 6.35 mm using the following procedure. Dried pellets of polymer are fed into a two-inch diameter single screw extruder using a flood feed hopper setup. The polymer is melted using heat and shearing created by the compression of the polymer as it is pushed along the extruder screw length. The polymer melt is than pushed through the die body and bushing opening to create a ring of polymer. This continuous ring of polymer is pulled through a sizer apparatus as it enters the quench tank. A small spray of water at the sizer entrance helps to hold the vacuum pressure constant and also acts as a lubricant between the sizer rings and the polymer. Once inside the water quench tank, the lower pressure from the vacuum level on the outside of the tube and the atmospheric pressure inside the tube, draws the tube out to the sizer's dimensions as the polymer is quenched to its final shape. Alternately, air pressure can be applied to the inside of the tube in place of a vacuum on the outside of the tube. The tube is then pulled at a constant rate through a cutter that cuts the tube to the desired sample length for testing.

1. A shaped article in the form of an extruded profile comprising a blend composition comprising:
(a) about 50 to about 75 weight % of polyamide comprising nylon-6 and optionally up to 40 weight %, based on the total polyamide component, of nylon-6,66, nylon-66, nylon-610, nylon-612, nylon-11, nylon-12 or mixtures thereof;
(b) about 25 to about 50 weight % of an ionomer, wherein the ionomer comprises at least one copolymer comprising copolymerized comonomers of ethylene, 3 to 20 weight % of at least one α,β-unsaturated C₃-C₈ monocarboxylic acid, and 0 to 30 weight % of alkyl acrylate or alkyl methacrylate; and 30 to 90% of the total carboxylic acid functionalities are neutralized to salts with a mixture of zinc cations and sodium or lithium cations, wherein the salts comprise from 20 to 90 % equivalents of zinc.

2. The article of claim 1 wherein the at least one copolymer is a dipolymer consisting essentially of copolymerized comonomers of ethylene and 12 to 20 weight % of acrylic acid or methacrylic acid.

3. The article of claim 1 wherein copolymerized units of alkyl acrylate or alkyl methacrylate are present in the copolymer from 0.1 to about 30 weight %.

4. The article of claim 1 wherein the salts comprise a mixture of zinc and sodium cations.

5. The article of claim 1 wherein the salts comprise a mixture of zinc and lithium cations.

6. The article of claim 1 wherein the polyamide consists essentially of nylon-6.

7. The article of claim 1 wherein the polyamide comprises nylon-6 and 0.1 to 40 weight % of nylon-6,66, nylon-66, nylon-610, nylon-612, nylon-11, nylon-12 or mixtures thereof.

8. The article of claim 1 wherein the composition further comprises non-ionomeric thermoplastic materials.

9. The article of claim 8 comprising from 1 to 15 weight % of an impact modifier comprising polyethylene, ethylene-propylene dipolymer, ethylene-propylene terpolymer with an additional α-olefin, or ethylenepropylene diene mononomer, grafted with a carboxylic acid or anhydride.

10. The article of claim 1 wherein the composition further comprises a sulfonamide plasticizer.

11. The article of claim 1 wherein the tensile modulus of the blend composition, as measured by ASTM D1708 at 23° C., is less than 1200 MPa.

12. The article of claim 11 wherein the tensile modulus of the blend composition is less than 1000 MPa.

13. The article of claim 12 wherein the tensile modulus of the blend composition is less than 800 MPa.

14. The article of claim 1 wherein the blend composition exhibits salt stress crack behavior when tested according to ASTM D1693 that is characterized by standard test plaques that exhibit no cracks when exposed to 50% aqueous zinc chloride solution at about 20 to about 25° C. for at least 24 hours.

15. The article of claim 14 wherein standard test plaques exhibit no cracks when exposed to 50% aqueous zinc chloride solution at about 20 to about 25° C. for at least seven days.

16. The article of claim 1 wherein the article is a hose, tubing, or pipe.

17. The article of claim 1 further comprising an additional layer comprising a material other than the blend composition.

18. A method for improving the salt stress crack behavior of a polyamide composition, comprising
(a) providing a polyamide composition comprising nylon-6 and optionally up to 40 weight %, based on the total polyamide component, of nylon-6,66, nylon-66, nylon-610, nylon-612, nylon-11, nylon-12 or mixtures thereof;
(b) melt blending the polyamide with an ionomer comprising at least one copolymer comprising copolymerized comonomers of ethylene, 3 to 20 weight % of at least one α,β-unsaturated C₃-C₈ monocarboxylic acid, and 0 to 30 weight % of alkyl acrylate or alkyl methacrylate; and 30 to 90% of the total carboxylic acid functionalities are neutralized to salts with a mixture of zinc cations and sodium or lithium cations, wherein the salts comprise from 20 to 90% equivalents of zinc; to provide a molten blend composition comprising about 50 to about 75 weight % of the polyamide and about 25 to about 50 weight % of the ionomer;
(c) shaping the molten blend composition into a defined shape;
(d) allowing the shaped molten blend composition to cool, thereby providing a shaped article;
wherein the salt stress crack behavior of the blend composition when tested according to ASTM D1693 is characterized by standard test plaques that exhibit fewer cracks than comparison test plaques consisting essentially of the polyamide composition of (a) when exposed to 50% aqueous zinc chloride solution at about 20 to about 25° C. for at least 24 hours.

19. The method of claim 18 wherein standard test plaques of the blend composition exhibit no cracks when exposed to 50% aqueous zinc chloride solution at about 20 to about 25° C. for at least 24 hours.

20. The method of claim 18 wherein standard test plaques of the blend composition exhibit no cracks when exposed to 50% aqueous zinc chloride solution at about 20 to about 25° C. for at least seven days.

21. The method of claim 18 wherein shaping the molten blend composition is by profile extrusion and the defined shape is a hose, tubing, or pipe.

22. The method of claim 18 wherein shaping the molten blend composition is by extrusion coating the molten blend composition onto a tubular substrate.
